(19) United States
(12) Patent Application Publication
(10) Pub. No.: US 2024/0080943 A1
(43) Pub. Date: Mar. 7, 2024

(54) HEATER CONTROL APPARATUS

(71) Applicant: ISUZU MOTORS LIMITED, Yokohama-shi (JP)

(72) Inventor: Takuya KIKUCHI, Fujisawa-shi (JP)

(21) Appl. No.: 18/458,179

(22) Filed: Aug. 30, 2023

(30) Foreign Application Priority Data
Sep. 1, 2022 (JP) 2022-139090

(51) Int. Cl. H05B 1/02; B60L 58/27

(52) U.S. Cl. CPC H05B 1/0236; B60L 58/27; B60L 2240/545

(57) ABSTRACT

A heater control apparatus including: a determination section configured to acquire first temperature information when the vehicle is brought into an unactuated state, the first temperature information indicating a temperature of an available battery pack to which the high-voltage relay is not yet connected and that is capable of being charged and discharged, the determination section being configured to determine whether or not the first temperature information indicates a temperature equal to or lower than a predetermined threshold; and a control section configured to acquire second temperature information indicating the temperature of the available battery pack after connection of the high-voltage relay of the available battery pack when the first temperature information indicates the temperature equal to or lower than the predetermined threshold, the control section being configured to control a heating operation of the battery heater based on the second temperature information.

### CROSS REFERENCE TO RELATED APPLICATIONS

This application is entitled to the benefit of Japanese Patent Application No. 2022-139090, filed on Sep. 1, 2022, the disclosure of which including the specification, drawings and abstract is incorporated herein by reference in its entirety.

### TECHNICAL FIELD

The present disclosure relates to a heater control apparatus.

### BACKGROUND ART

When an in-vehicle battery is placed in a cryogenic environment, charging and discharging may be difficult. As a result, a situation in which the vehicle cannot be started may occur. As a countermeasure, conventionally, it has been known that the in-vehicle battery is heated with a battery heater to make it possible to charge or discharge the in-vehicle battery (for example, refer to Patent Literature (hereinafter, referred to as “PTL”) 1).

### CITATION LIST

### Patent Literature

PTL 1: Japanese Patent Application Laid-Open No. 2018-86878

### SUMMARY OF INVENTION

### Technical Problem

PTL 1 assumes that a vehicle includes one battery and the battery is heated in the vehicle. In contrast, in a vehicle including a plurality of batteries, an available battery is appropriately changed (selected), and therefore a contrivance for efficiently heating the batteries is required.

An object of one aspect of the present disclosure is to provide a heater control apparatus capable of efficiently achieving heating of a plurality of batteries in a cryogenic environment in a vehicle in which the plurality of batteries are mounted.

### Solution to Problem

A heater control apparatus according to an aspect of the present disclosure is used in a vehicle equipped with a plurality of battery packs and a battery heater for heating the plurality of battery packs, the plurality of battery packs including a high-voltage relay, the heater control apparatus including: a determination section configured to acquire first temperature information when the vehicle is brought into an unactuated state, the first temperature information indicating a temperature of an available battery pack to which the high-voltage relay is not yet connected and that is capable of being charged and discharged, the determination section being configured to determine whether or not the first temperature information indicates a temperature equal to or lower than a predetermined threshold; and a control section configured to acquire second temperature information indicating the temperature of the available battery pack after connection of the high-voltage relay of the available battery pack when the first temperature information indicates the temperature equal to or lower than the predetermined threshold, the control section being configured to control a heating operation of the battery heater based on the second temperature information.

### Advantageous Effects of Invention

According to the present disclosure, it is possible to efficiently achieve heating a battery in a vehicle equipped with a plurality of batteries in a cryogenic environment.

### BRIEF DESCRIPTION OF DRAWINGS

FIG. 1 is a schematic diagram illustrating a configuration of a battery pack system according to an embodiment of the present disclosure;

FIG. 2 is a block diagram illustrating a configuration of a VCU according to the embodiment of the present disclosure; and

FIG. 3 is a flowchart illustrating an operation of the VCU according to the embodiment of the present disclosure.

### DESCRIPTION OF EMBODIMENTS

Hereinafter, an embodiment of the present disclosure will be described with reference to the drawings.

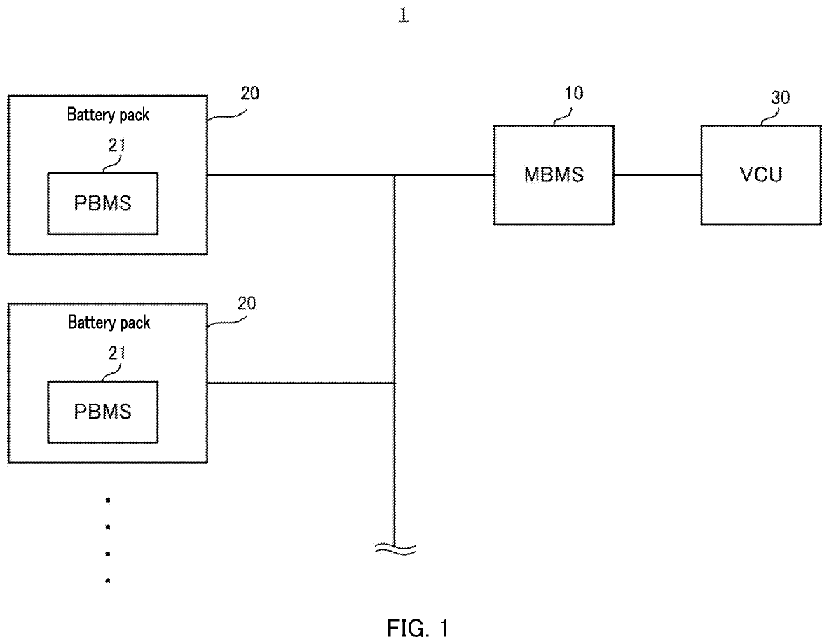

To begin with, the configuration of battery pack system 1 according to the present embodiment will be described with reference to FIG. 1. FIG. 1 is a schematic diagram illustrating an exemplary configuration of battery pack system 1.

Battery pack system 1 illustrated in FIG. 1 is mounted in a vehicle (for example, an electric vehicle).

Battery pack system 1 includes one Master Battery Management System (MBMS) 10, a plurality of battery packs 20, and one Vehicle Control Unit (VCU) 30.

The plurality of battery packs 20 are connected in parallel. Pack Battery Management System (PBMS) 21 is built in each of battery packs 20.

Although not illustrated, each of battery packs 20 includes a chargeable/dischargeable secondary battery, a high-voltage relay (for example, a positive-side relay and/or a negative-side relay), a resistor, a voltmeter, an ammeter, a temperature sensor, and the like.

Although two battery packs 20 are illustrated in FIG. 1, the number of battery packs 20 may be two or more.

VCU 30 is a computer that performs a general control of a vehicle. VCU 30 corresponds to a host computer (controller) of MBMS 10. VCU 30 corresponds to one example of the “heater control apparatus” of the present disclosure.

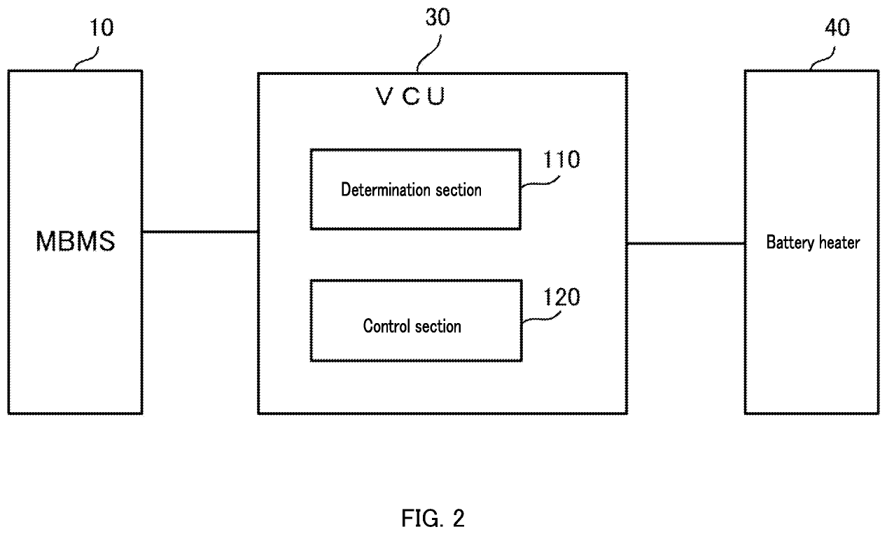

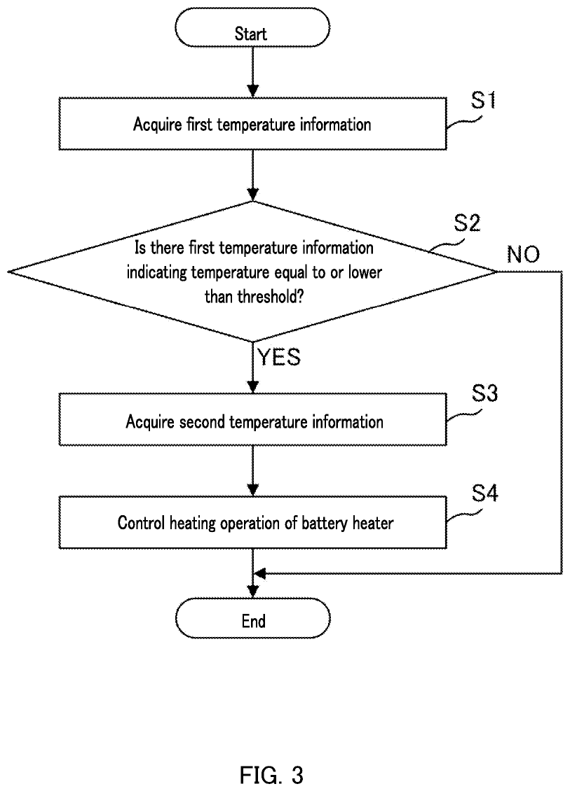

VCU 30 will be described later with reference to FIGS. 2 and 3.

MBMS 10 is a computer that mainly manages each battery pack 20. MBMS 10 corresponds to a host computer (controller) of PBMS 21. PBMS 21 corresponds to one example of “battery management apparatus” of the present disclosure.

PBMS 21 is a computer that mainly monitors the state of battery pack 20 and controls driving of the high-voltage relay. Examples of the state of battery pack 20 include a current, a voltage, a temperature, a degree of degradation, and a charge level (State Of Charge (SOC)) in battery pack 20. These values are sent to MBMS 10 as state information.

Communication between MBMS 10 and VCU 30 and communication between MBMS 10 and each PBMS 21 use a Controller Area Network (CAN). Therefore, each PBMS 21 and MBMS 10 are electrically connected to each other via a CAN communication line (whose reference sign is omitted). MBMS 10 and VCU 30 are electrically connected to each other via the CAN communication line (whose reference sign is omitted).

In the present embodiment, PBMS 21 transmits the state information indicating the state of battery pack 20 to MBMS 10. Then, based on pieces of the state information, MBMS 10 recognizes which of the plurality of battery packs 20 is a chargeable/dischargeable battery pack (which may be referred to as a non-failed battery pack; hereinafter, referred to as an available battery pack). Further, MBMS 10 recognizes for each of the plurality of battery packs 20 whether or not the high-voltage relay is connected. These recognition processes are performed, for example, in a “key-on period” of the vehicle (when the key of the vehicle is brought into an ON state).

Further, based on a vehicle mode (for example, a charging mode or a discharging mode) notified from VCU 30 and the state information (specifically, the charging state) received from each PBMS 21, MBMS 10 selects a battery pack to which the high-voltage relay should be connected from among available battery packs to which the high-voltage relay is not yet connected. Further, after the connection of the high-voltage relay of the selected battery pack is made, MBMS 10 recognizes the battery pack (that is, the available battery pack in which the connection of the high-voltage relay has been performed) as a relay-connected battery pack.

In the present embodiment, MBMS 10 transmits temperature information (included in each state information) indicating the temperature of each battery pack 20 to VCU 30. For example, MBMS 10 transmits, to VCU 30, the temperature information (corresponding to one example of the first temperature information) indicating the temperature of the available battery pack prior to the connection of the high-voltage relay. Further, for example, MBMS 10 transmits, to VCU 30, the temperature information (corresponding to one example of the second temperature information) indicating the temperature of the available battery pack after the connection of the high-voltage relay.

The configuration of battery pack system 1 has been described above.

Next, the configuration of VCU 30 according to the present embodiment will be described with reference to FIG. 2. FIG. 2 is a block diagram illustrating an exemplary configuration of VCU 30.

Although not illustrated, VCU 30 includes, as hardware, for example, a Central Processing Unit (CPU), a Read Only Memory (ROM) in which a computer program is stored, and a Random Access Memory (RAM), which is a working memory. The functions described below are implemented by the CPU executing, in the RAM, the computer program read from the ROM.

As illustrated in FIG. 2, VCU 30 is electrically connected to each of MBMS 10 and battery heater 40.

Battery heater 40 is an apparatus that heats each battery pack 20 illustrated in FIG. 1. Battery heater 40 operates using the electric power of each battery pack 20. The heating operation of battery heater 40 is controlled by VCU 30.

As illustrated in FIG. 2, VCU 30 includes determination section 110 and control section 120.

Determination section 110 acquires the first temperature information from MBMS 10 when the vehicle is brought into an unactuated state (for example, in a key-off period or when the ignition is turned off). The unactuated state is a state in which all the high-voltage relays of battery packs 20 are not connected (before connection).

The first temperature information is information indicating the temperature of the available battery pack to which the high-voltage relay is not yet connected (in other words, the temperatures of all the available battery packs).

Then, determination section 110 determines whether or not there is the first temperature information which indicates a temperature equal to or lower than a predetermined threshold among the pieces of first temperature information acquired.

The threshold is an upper limit value allowing determination that heating is necessary, and is set in advance based on a result of an experiment, a simulation, or the like.

When even a single piece of first temperature information indicates the temperature equal to or lower than the threshold, determination section 110 determines that heating by battery heater 40 is necessary. On the other hand, when there is no first temperature information indicating the temperature equal to or lower than the threshold, determination section 110 determines that heating by battery heater 40 is unnecessary.

Note that after the vehicle is brought into the unactuated state, determination section 110 may periodically acquire the first temperature information, and determine whether or not there is any first temperature information indicating the temperature equal to or lower than the threshold.

When there is the first temperature information indicating the temperature equal to or lower than the threshold (i.e., when heating by the battery heaters 40 is necessary), connection of the high-voltage relay of the available battery pack is performed under the control of MBMS 10.

In particular, to begin with, control section 120 acquires the second temperature information from MBMS 10.

The second temperature information is information indicating the temperature of the available battery pack to which the high-voltage relay has been connected.

Control section 120 controls the heating operation of battery heater 40 based on the second temperature information. For example, control section 120 operates battery heater 40 such that the temperature indicated by the second temperature information is made equal to or higher than a predetermined target temperature. Accordingly, battery pack 20 is heated by battery heater 40.

The configuration of VCU 30 has been described above.

Next, the operation of VCU 30 will be described with reference to FIG. 3. FIG. 3 is a flowchart illustrating the operation of VCU 30.

The process illustrated in FIG. 3 is started, for example, when the vehicle is brought into the unactuated state (for example, the key-off period).

To begin with, determination section 110 acquires the first temperature information from MBMS 10 (step S1).

Next, determination section 110 determines whether or not there is any first temperature information among the pieces of acquired first temperature information which indicates a temperature equal to or lower than the threshold (step S2).

When there is no first temperature information indicating the temperature equal to or lower than the threshold (S2: NO in steps), it is determined that heating by battery heater 40 is not necessary, and the process ends. In this case, the process may be started again from step S1.

On the other hand, when there is the first temperature information indicating the temperature equal to or lower than the threshold (step S2: YES), it is determined that heating by battery heater 40 is necessary, and the process proceeds to step S3.

Here, connection of the high-voltage relay of the available battery pack is performed under the control of MBMS 10.

Next, control section 120 acquires the second temperature information from MBMS 10 (step S3).

Then, control section 120 controls the heating operation of battery heater 40 based on the second temperature information (step S4).

Thus, battery pack 20 is heated by battery heater 40.

As described above, VCU 30 of the present embodiment is used in a vehicle equipped with a plurality of battery packs 20 and battery heater 40 for heating the plurality of battery packs 20, the plurality of battery packs 20 including a high-voltage relay, VCU 30 being characterized by including: determination section 110 configured to acquire the first temperature information when the vehicle is brought into an unactuated state, the first temperature information indicating the temperature of available battery pack 20 among the plurality of battery packs 20 to which the high-voltage relay is not yet connected and that is capable of being charged and discharged, determination section 110 being configured to determine whether or not the first temperature information indicates a temperature equal to or lower than a predetermined threshold; and control section 120 configured to acquire the second temperature information after connection of the high-voltage relay of available battery pack 20 when the first temperature information indicates the temperature equal to or lower than the predetermined threshold, the second temperature information indicating the temperature of available battery pack 20, control section 120 being configured to control the heating operation of battery heater 40 based on the second temperature information.

According to this feature, VCU 30 of the present embodiment is capable of efficiently achieving heating of the batteries in a cryogenic environment in a vehicle in which a plurality of batteries are mounted. In the cryogenic environment, the temperatures of battery packs 20 decrease in the key-off period, and charging or discharging may be impossible in the key-on period. According to VCU 30 of the present exemplary embodiment, battery packs 20 are heated to a predetermined target temperature or higher, or the temperatures of battery packs are kept at a temperature equal to or higher than the predetermined target temperature. Accordingly, charging or discharging can also be performed.

Further, the first temperature information is used in determination section 110 and the second temperature information is used in control section 120. Thus, the following operational effects can be obtained. The temperature of the second temperature information reflects a temperature rise caused by battery heater 40 and a temperature rise caused by self-heating of battery pack 20. On the other hand, only the temperature rise caused by battery heater 40 is reflected in the temperature of the first temperature information. Accordingly, a rise in the temperature of the second temperature information is faster than a rise in the temperature of the first temperature information. Thus, the determination process of determining completion of heating of the relay-connected battery pack is quick. That is, the frequency at which charging and discharging can be permitted is increased even in a cryogenic environment.

Note that the present disclosure is not limited to the description of the above-described embodiment, and various modifications can be made without departing from the gist thereof.

The heater control apparatus of the present disclosure is useful for the case where a vehicle equipped with a plurality of battery packs is in a cryogenic environment.

1. A heater control apparatus used in a vehicle equipped with a plurality of battery packs and a battery heater for heating the plurality of battery packs, the plurality of battery packs including a high-voltage relay, the heater control apparatus comprising:
a determination section configured to acquire first temperature information when the vehicle is brought into an unactuated state, the first temperature information indicating a temperature of an available battery pack to which the high-voltage relay is not yet connected and that is capable of being charged and discharged, the determination section being configured to determine whether or not the first temperature information indicates a temperature equal to or lower than a predetermined threshold; and
a control section configured to acquire second temperature information indicating the temperature of the available battery pack after connection of the high-voltage relay of the available battery pack when the first temperature information indicates the temperature equal to or lower than the predetermined threshold, the control section being configured to control a heating operation of the battery heater based on the second temperature information.

2. The heater control apparatus according to claim 1, wherein
after the vehicle is brought into the unactuated state, the determination section periodically acquires the first temperature information and determines whether or not the first temperature information indicates the temperature equal to or lower than the threshold.

3. The heater control apparatus according to claim 1, wherein
the determination section acquires the first temperature information from a battery management apparatus configured to manage a state of each of the plurality of battery packs.
